(19) United States
(12) Patent Application Publication
(10) Pub. No.: US 2016/0302052 A1
(43) Pub. Date: Oct. 13, 2016

(54) Method, apparatus and system for d2d device discovery

(71) Applicant: ZTE CORPORATION, Shenzhen (CN)

(72) Inventor: Hui Xu, Shenzhen (CN)

(21) Appl. No.: 15/026,913

(22) PCT Filed: Mar. 3, 2014
(86) PCT No.: PCT/CN2014/072818

§ 371 Date: Apr. 26, 2016

(30) Foreign Application Priority Data
Sep. 26, 2013 (CN) 201310446669.9

(51) Int. Cl. H04W 8/00; H04W 8/14; H04W 48/16

(52) U.S. Cl. CPC H04W 8/005; H04W 48/16; H04W 8/14

(57) ABSTRACT

The disclosure provides a method for discovering a Device to Device (D2D) device. The method comprises: a source D2D device determines whether there is network coverage currently, if so, the source D2D device sends a request to discover one or more proximity D2D devices, receives wireless resource information, sends announcement information according to the wireless resource information and monitors response information; and, if not, the source D2D device sends announcement information according to the wireless resource information preconfigured in the source D2D device and monitors response information. The disclosure also provides a system and an apparatus for discovering D2D device. The disclosure can realize discovery between D2D devices, reduce the power consumption of D2D device and improve the discovery efficiency of D2D device.

### TECHNICAL FIELD

The disclosure relates to the field of communications, and in particular to a method, an apparatus and a system for discovering a Device to Device (D2D) device.

### BACKGROUND

D2D communication refers to the direct communication between proximity devices, for example, Bluetooth. The D2D communication generally adopts an unlicensed spectrum, such as, 2.4 GHz. The D2D communication includes two aspects: discovery and communication. Discovery is to identify in a proximity area the User Equipment (UE) having D2D capability and applying a D2D application, and communication refers that D2D devices transmit user plane data through direction connections between users or through an Evolved Node B (eNB). The usage scene of D2D technology includes network coverage (for example, commercial application) and no network coverage of (for example, public safety communication). As for the scene of network coverage, the process is generally implemented by a control plane managing D2D at the network side. As for the scene of no network coverage, the control plane process is generally implemented by the D2D device itself. However, present technologies cannot provide a method for discovery between D2D devices.

### SUMMARY

In view of this, the disclosure is intended to provide a method, an apparatus and a system for discovering a D2D device, which can realize discovery between D2D devices, reduce the power consumption of D2D device and improve the discovery efficiency of D2D device.

The embodiment of the disclosure provides a method for discovering a D2D device, including:

a source D2D device determines whether there is network coverage; when there is network coverage, the source D2D device sends a request to discover one or more proximity D2D devices, receives wireless resource information, sends announcement information according to the wireless resource information and monitors response information; and

when there is no network coverage, the source D2D device sends announcement information according to the wireless resource information preconfigured in the source D2D device and monitors response information.

In the scheme above, determining whether there is network coverage includes:

the source D2D device determines whether there is network coverage according to the signaling interaction with a network side and the network side context information saved in the source D2D device; if the source D2D device has a normal signaling interaction with the network side and the source D2D device has saved the network side context information, the source D2D device determines that there is network coverage; otherwise, the source D2D device determines that there is no network coverage.

In the scheme above, the request to discover one or more proximity D2D devices includes at least one of the following: a source identifier, a target identifier, an application identifier, an application server identifier, a group identifier, a network coverage indication, a discovery scope, a discovery time window.

In the scheme above, the wireless resource information includes at least one of the following: a frequency, a frame/sub-frame, a repetition interval, a resource index.

In the scheme above, the announcement information includes at least one of the following: a source identifier, a target identifier, an application identifier, a group identifier, a network coverage indication, whether to support relay, discovery scope, a discovery time window.

In the scheme above, the response information is: receipt acknowledgement information sent to the source D2D device by a target D2D device, after the target D2D device receives the announcement information sent from the source D2D device; the response information is sent by the target D2D device on an allocated or a preconfigured wireless resource.

In the scheme above, the wireless resource information, the announcement information and the response information are sent through wireless resource control signaling.

The embodiment of the disclosure further provides a method for discovering a D2D device, including:

after a D2D gateway receives a request to discover one or more proximity D2D devices, the D2D gateway sends indication information to an Evolved Node B (eNB) through a Mobile Management Entity (MME);

the eNB allocates a wireless resource for the D2D device according to the indication information and sends the wireless resource information.

In the scheme above, after the D2D gateway receives a request to discover one or more proximity D2D devices, sending, by the D2D gateway, indication information to an eNB through an MME includes:

the D2D gateway determines whether the source D2D device and target D2D device in the request to discover one or more proximity D2D devices allow to discover or be discovered according to subscription data or locally stored data; if not, the D2D gateway sends rejection indication information and rejection reason to the source D2D device;

otherwise, the D2D gateway sends indication information to the MME on which the source D2D device and target device are located.

In the scheme above, the indication information includes at least one of the following: a source identifier, a target identifier, an application identifier, a group identifier, a network coverage indication, a discovery scope, a discovery time window.

The embodiment of the disclosure also provides a D2D device, including: an application unit and a D2D unit, wherein

the application unit is configured to: determine whether there is network coverage, if so, send a request to discover one or more proximity D2D devices to the D2D unit, send announcement information through the D2D unit according to the wireless resource information and monitor response information; if not, send announcement information through the D2D unit according to a preconfigured wireless resource information and monitor response information;

the D2D unit is configured to: send the request to discover one or more proximity D2D devices sent from the application unit, send the received wireless resource information to the application unit, and send out the announcement information sent from the application unit and monitor response information.

In the scheme above, the application unit specifically is configured to: determine whether there is network coverage according to the signaling interaction with a network side and the saved network side context information, and, if there is a normal signaling interaction with the network side and the network side context information already exists, determine that there is network coverage; otherwise, determine that there is no network coverage.

In the scheme above, the request to discover one or more proximity D2D devices includes at least one of the following: a source identifier, a target identifier, an application identifier, an application server identifier, a group identifier, a network coverage indication, a discovery scope, a discovery time window.

In the scheme above, the wireless resource information includes at least one of the following: a frequency, a frame/sub-frame, a repetition interval, a resource index.

In the scheme above, the announcement information includes at least one of the following: a source identifier, a target identifier, an application identifier, a group identifier, a network coverage indication, whether to support relay, a discovery scope, a discovery time window.

In the scheme above, the response information is: receipt acknowledgement information sent to the source D2D device by a target D2D device, after the target D2D device receives the announcement information sent from the source D2D device; the response information is sent by the target D2D device on an allocated or preconfigured wireless resource.

In the scheme above, the wireless resource information, the announcement information and the response information are sent through wireless resource control signaling.

The embodiment of the disclosure also provides a network side sub-system, including: an eNB, an MME and a D2D gateway, wherein

the D2D gateway is configured to send indication information to the MME after receiving a request to discover one or more proximity D2D devices;

the MME is configured to send the indication information sent from the D2D gateway to the eNB; and

the eNB is configured to allocate a wireless resource for the D2D device according to the indication information and to send the wireless resource information.

In the scheme above, the D2D gateway specifically is configured to: determine whether the source D2D device and target D2D device in the request to discover one or more proximity D2D devices allow to discover or be discovered according to subscription data or locally stored data, if not, send rejection indication information and rejection reason to the source D2D device; otherwise, send indication information to the MME on which the source D2D device and target device are located.

In the scheme above, the indication information includes at least one of the following: a source identifier, a target identifier, an application identifier, a group identifier, a network coverage indication, a discovery scope, a discovery time window.

The embodiment of the disclosure provides a system for D2D device discovery, including: a D2D device described in any one of the above schemes; and a network side sub-system described in any one of the above schemes.

In the method, apparatus and system provided by the disclosure for D2D device discovery, a source D2D device determines whether there is network coverage; if so, the source D2D device sends a request to discover one or more proximity D2D devices, receives wireless resource information, sends announcement information according to the wireless resource information and monitors response information; and if not, the source D2D device sends announcement information according to the wireless resource information preconfigured in the source D2D device and monitors response information. In this way, the discovery of D2D device can be realized only if an announcement message is sent according to the specified wireless resource, which can avoid the circular sending of announcement information and the continuous monitoring of response information, thereby reducing the power consumption of D2D device; in addition, the disclosure can avoid the aimless circular sending of announcement notice and the continuous monitoring of response, thereby improving the discovery efficiency between D2D devices.

### BRIEF DESCRIPTION OF THE DRAWINGS

FIG. 1 is a flowchart of a method according to embodiment 1 of the disclosure;

FIG. 2 is a flowchart of a method according to embodiment 2 of the disclosure;

FIG. 3 is a flowchart of a method according to embodiment 3 of the disclosure;

FIG. 4 is a flowchart of a method according to embodiment 4 of the disclosure;

FIG. 5 is a flowchart of a method according to embodiment 5 of the disclosure;

FIG. 6 is a structure diagram of a D2D device according to embodiment 6 of the disclosure; and

FIG. 7 is a structure diagram of a system according to embodiment 7 of the disclosure.

### DETAILED DESCRIPTION

A source D2D device determines whether there is network coverage; if so, the source D2D device sends a request to discover one or more proximity D2D devices, receives wireless resource information and sends announcement information according to the wireless resource information; if not, the source D2D device sends announcement information according to preconfigured wireless resource information.

The disclosure is described below in further detail in conjunction with accompanying drawings and specific embodiments.

### Embodiment 1

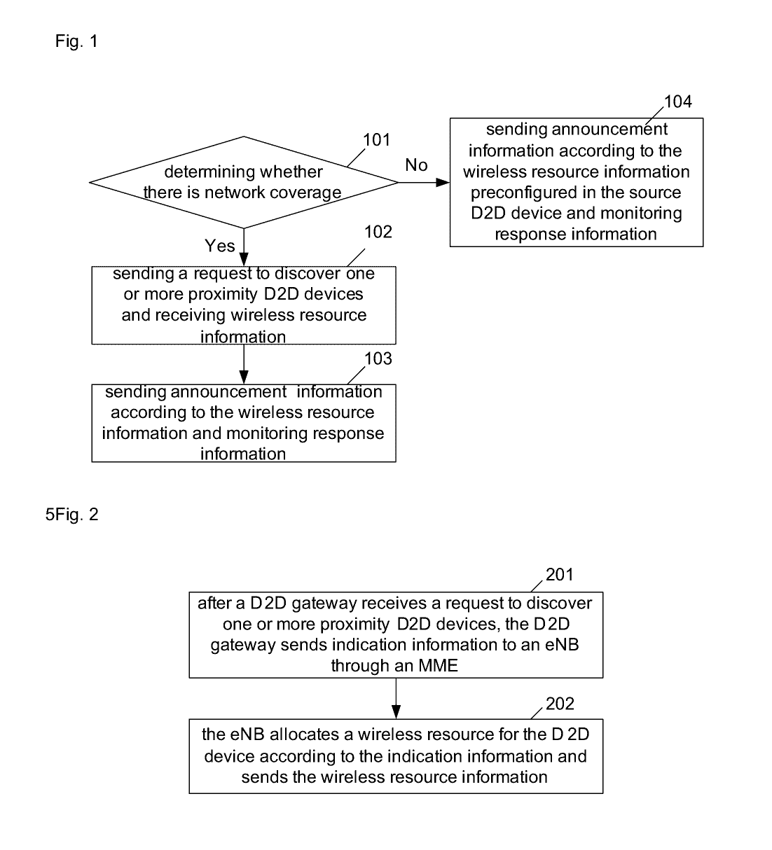

In the method for discovering a D2D device provided by the embodiment of the disclosure, the operation process at the D2D device side as shown in FIG. 1 includes:

S101: a source D2D device determines whether there is network coverage; if so, S102 is implemented; otherwise, S104 is implemented.

Here, determining whether there is network coverage includes: the source D2D device determines whether there is network coverage according to the signaling interaction with a network side and the context information in the source D2D device; if the source D2D device has a normal signaling interaction with the network side and the source D2D device has the network side context information, the source D2D device determines that there is network coverage; otherwise, the source D2D device determines that there is no network coverage.

The network coverage means that all D2D devices (including source and target D2D devices) involved in D2D discovery are located in the network coverage; if one or more of the source and target D2D devices are not in the network coverage, it is considered that there is no network coverage.

The source D2D device is a device which has the D2D discovery and communication capability and is subscribed to use the D2D function.

S102: the source D2D device sends a request to discover one or more proximity D2D devices and receives wireless resource information.

Here, the request to discover one or more proximity D2D devices includes at least one of the following: a source identifier, a target identifier, an application identifier, an application server identifier, a group identifier, a network coverage indication, a discovery scope, a discovery time window.

The source identifier is used to indicate the D2D device that sends the request; the target identifier is used to indicate the target device expected to be discovered; the discovery scope is used to indicate the area for discovering the target; the discovery time window is used to indicate the valid time for discovery.

The wireless resource information is realized through Radio Resource Control (RRC) signaling; and the wireless resource information includes at least one of the following: frequency, frame/sub-frame, repetition interval, resource index.

The resource index is used to indicate the wireless resource needed for different D2D discovery requirements, for example, point to point, point to multi-point, different distances between devices and other requirements; the wireless resource adopts an uplink wireless resource, that is, the air interface resource from UE to base station. The wireless resource is used for discovery between D2D devices.

The repetition interval is the time interval for the D2D device to send/monitor announcement information on the wireless resource.

S103: the source D2D device sends announcement information according to the wireless resource information and monitors response information. The process is ended.

Here, the announcement information includes at least one of the following: a source identifier (which is used to indicate the D2D device that sends the request), a target identifier (which is used to indicate the target device expected to be discovered), an application identifier, a group identifier, a network coverage indication, whether to support relay (which is used to indicate serving as relay), a discovery scope (which is used to indicate the area for discovering the target), a discovery time window (which is used to indicate the valid time for discovery) and the like. The D2D announcement information is sent through RRC signaling.

The response information is: acknowledgement information of receipt sent to the source D2D device by the proximity D2D device, after the proximity D2D device receives the announcement information sent from the source D2D device. The response information is sent by the target D2D device on an allocated or preconfigured wireless resource. The response information is sent through air interface RRC signaling.

S104: the source D2D device sends announcement information according to the wireless resource information preconfigured in the source D2D device and monitors response information.

The preconfigured wireless resource information includes at least one of the following: frequency, frame/sub-frame, repetition interval (which is used to indicate the time interval for the D2D device to send/monitor announcement information on the wireless resource), and resource index. The preconfigured wireless resource is a D2D dedicated wireless resource, which generally adopts the uplink wireless resource.

### Embodiment 2

In the method for D2D device discovery provided by the embodiment of the disclosure, the operation process at the network side as shown in FIG. 2 includes:

S201: after a D2D gateway receives a request to discover one or more proximity D2D devices, the D2D gateway sends indication information to an eNB through an MME.

Specifically, the D2D gateway determines whether the source D2D device and target D2D device in the request to discover one or more proximity D2D devices allow to discover or be discovered according to subscription data or locally stored data; if not, the D2D gateway sends rejection indication information and rejection reason to the source D2D device; otherwise, the D2D gateway sends indication information to the MME on which the source D2D device and target device are located.

The source D2D device and target D2D device might be located on the same or different MMEs.

The D2D gateway determines the information of the MME on which the D2D device is located according to D2D device identifier and D2D device registration information.

The MME sends indication information to the eNB on which the source D2D device and target D2D device are located; the source and target D2D devices might be located on the same or different eNBs. The MME determines the eNB on which the D2D device is located according to the D2D device registration information.

The indication information includes at least one of the following: a source identifier (which is used to indicate the D2D device that sends the request), a target identifier (which is used to indicate the target device expected to be discovered), an application identifier, a group identifier, a network coverage indication, a discovery scope (which is used to indicate the area for discovering the target), a discovery time window (which is used to indicate the valid time for discovery) and the like. The discovery time window can be realized by a timer.

S202: the eNB allocates a wireless resource for the D2D device according to the indication information and sends the wireless resource information.

### Embodiment 3

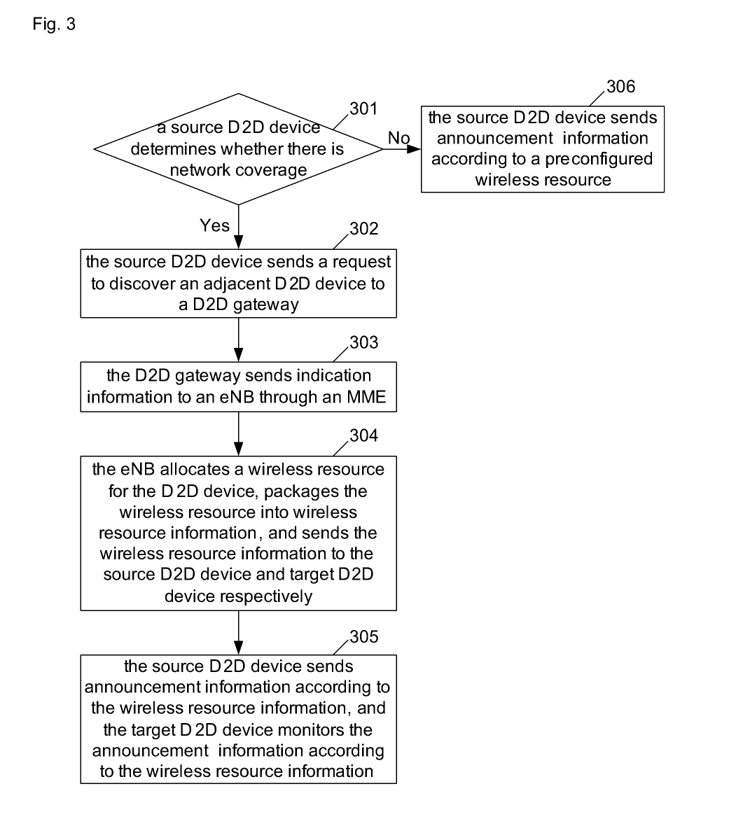

The method for D2D device discovery provided by the embodiment of the disclosure as shown in FIG. 3 includes:

S301: a source D2D device determines whether there is network coverage; if so, S302 is implemented.; otherwise, S306 is implemented.

Here, determining whether there is network coverage includes: the source D2D device determines whether there is network coverage according to the signaling interaction with a network side; if the source D2D device has a normal signaling interaction with the network side, the source D2D device determines that there is network coverage; otherwise, the source D2D device determines that there is no network coverage. The network coverage means that all D2D devices (including source and target D2D devices) involved in D2D discovery are located in the network coverage.

The source D2D device is a device which has the D2D discovery and communication capability and is subscribed to use the D2D function.

S302: the source D2D device sends a request to discover one or more proximity D2D devices to a D2D gateway.

Here, the D2D gateway is a network control plane node deployed to implement the D2D function, which might be a single physical node or a logical node attached to other physical nodes; the D2D gateway can be named as needed, for example, D2D control function, D2D server and so on.

The D2D device sends the discovery request message to the D2D gateway through control plane signaling; here, the control plane signaling is dedicated for D2D discovery.

The proximity D2D device is a D2D device in a proximity area, wherein the proximity area is an area meeting a preconfigured rule, that is, a D2D device can be discovered in this area. There might be one or multiple proximity D2D devices, wherein multiple proximity D2D devices generally belong to a common group, while one 5proximity D2D device generally is: a device which runs the same application (such as, social application, game, entertainment, shopping and other applications) as the D2D device initiating the request, or a device of which the user is a friend of the user of the D2D device initiating the request.

Here, the request to discover one or more proximity D2D devices includes at least one of the following: a source identifier, a target identifier, an application identifier, an application server identifier, a group identifier, a network coverage indication, a discovery scope, a discovery time window.

The source identifier is used to indicate the D2D device that sends the request; the target identifier is used to indicate the target device expected to be discovered; the 15discovery scope is used to indicate the area for discovering the target; the discovery time window is used to indicate the valid time for discovery.

The wireless resource information is realized through RRC signaling; and the wireless resource information includes at least one of the following: frequency, frame/sub-frame, repetition interval, resource index.

The repetition interval is the time interval for indicating the D2D device to send/monitor announcement information on the wireless resource.

S303: the D2D gateway sends indication information to an eNB through an MME.

Specifically, the D2D gateway determines whether the source D2D device and target D2D device have a discovery function and whether they allow to discover or be 25discovered according to subscription data or locally stored data; if not, the D2D gateway sends rejection indication information to the source D2D device, specifying rejection reason; otherwise, the D2D gateway sends indication information to the MME on which the source D2D device and target device are located.

The source D2D device and target D2D device might be located on the same or different MMEs.

The D2D gateway determines the information of the MME on which the D2D device is located according to D2D device identifier and D2D device registration information.

The MME sends indication information to the eNB on which the source D2D device and target D2D device are located; the source and target D2D devices might be located on the same or different eNBs. The MME determines the eNB on which the D2D device is located according to the D2D device registration information.

The indication information includes at least one of the following: a source identifier (which is used to indicate the D2D device that sends the request), a target identifier (which is used to indicate the target device expected to be discovered), an application identifier, a group identifier, a network coverage indication, a discovery scope (which is used to indicate the area for discovering the target), a discovery time window (which is used to indicate the valid time for discovery) and the like. The discovery time window can be realized by a timer.

S304: the eNB allocates a wireless resource for the D2D device, packages the wireless resource into wireless resource information, and sends the wireless resource information to the source D2D device and target D2D device respectively.

The eNB might be an eNB on which the source D2D device and target D2D device are located; there might be one or more eNBs (if there are multiple target D2D devices).

The wireless resource adopts the uplink resource (UE to eNB), which might be dedicated or common.

S305: the source D2D device sends announcement information according to the 20wireless resource information, and the target D2D device monitors the announcement information according to the wireless resource information. The process is ended.

The source D2D device sends announcement information through the wireless resource, and the target D2D device monitors the announcement information through the wireless resource.

The D2D announcement information is used to indicate D2D discovery, including at least one of the following: a source identifier (which is used to indicate the D2D device that sends the request), a target identifier (which is used to indicate the target device expected to be discovered), an application identifier, a group identifier, a network coverage indication, whether to support relay (which is used to indicate serving as relay), a discovery scope (which is used to indicate the area for discovering the target), a discovery time window (which is used to indicate the valid time for discovery) and the like. The D2D announcement information is sent through RRC signaling.

The target D2D device monitors the announcement information on the wireless resource; if the target D2D device has monitored the D2D announcement information, the target D2D device sends a response message to the source D2D device through the wireless resource, wherein the response message is used to indicate that the target D2D device receives the announcement information, and the response message is sent through RRC signaling.

When the source D2D device receives the response message from the target D2D device, the source D2D device further establishes a wireless connection with the target D2D device to perform D2D communication.

S306: the source D2D device sends announcement information according to a preconfigured wireless resource.

The D2D device being not in the network coverage including two conditions: 1) both source and target D2D devices are not in the network coverage; 2) one party of source and target D2D devices is in the network coverage; the source and target D2D devices send and monitor D2D announcement information according to the preconfigured wireless resource.

The preconfiguredting means that the wireless resource is stored in the D2D device before D2D discovery; and preconfiguredting can be realized through the allocation by a network side when the D2D device is located in the network coverage or through the pre-configuration in the D2D device by a D2D device manufacturer.

The preconfigured wireless resource information includes at least one of the following: frequency, frame/sub-frame, repetition interval (which is used to indicate the time interval for the D2D device to send/monitor announcement information on the wireless resource.), and resource index (which is used to indicate the wireless resource 25needed for different D2D discovery requirements, for example, point to point, point to multi-point, different distances between devices and other requirements).

The target D2D device monitors the announcement information on the wireless resource; if the target D2D device has monitored the D2D announcement information, the target D2D device sends a response message to the source D2D device through the wireless resource, wherein the response message is used to indicate that the target D2D device receives the announcement information, and the response message is sent through RRC signaling.

When the source D2D device receives the response message from the target D2D device, the source D2D device further establishes a wireless connection with the target D2D device to perform D2D communication.

### Embodiment 4

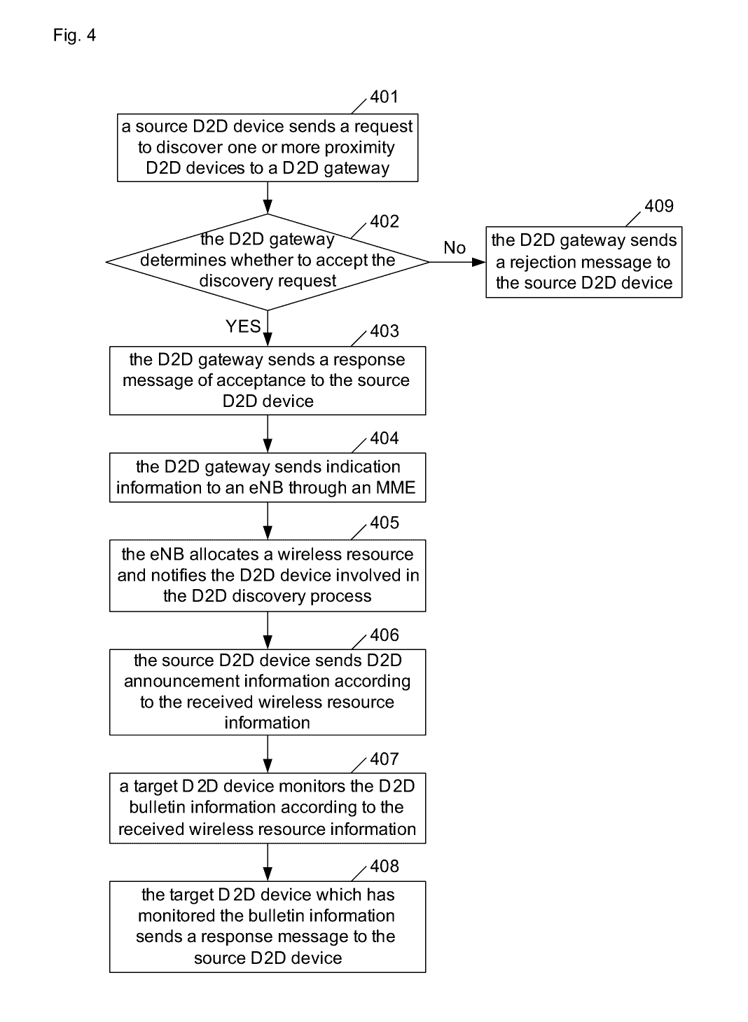

For the scene that a D2D device discovers a proximity D2D device in the condition of network coverage, the method for D2D device discovery as shown in FIG. 4 includes:

S401: a source D2D device sends a request to discover one or more proximity D2D devices to a D2D gateway.

There is a direct interface between the source D2D device and the D2D gateway. The D2D gateway belongs to a control plane node, which exists in both visited network and home network; if the source D2D device is in a roaming scene, it sends a request message through the D2D gateway in the visited network; otherwise, it sends a request message through the D2D gateway in the home network.

The request to discover one or more proximity D2D devices is control planning signaling, and the request message includes at least one of the following: a source identifier, a target identifier, an application identifier, an application server identifier (which is used to indicate the information of the server on which the application is located), a group identifier, a network coverage indication, a discovery scope (which is used to indicate the area for discovering the target), discovery time window (which is used to indicate the valid time for discovery) and the like. If the target is a specified D2D device, the target identifier is applied; if the target is a group of D2D devices, the group identifier is applied; if the target is a D2D device running a specified application, the application identifier is applied.

S402: the D2D gateway determines whether to accept the discovery request; if so, S403 is implemented; otherwise, S409 is implemented.

Here, the D2D gateway determines whether to accept the request according to the following conditions: whether the D2D device involved in the discovery has a D2D discovery function, whether the D2D device involved in the discovery allow D2D discovery/being discovered, whether the source D2D device and target device belong to the same group when the target D2D device is a group of D2D devices; if the above conditions are positive, the D2D gateway accepts the discovery request; otherwise, the D2D gateway rejects the discovery request.

S403: the D2D gateway sends a response message of acceptance to the source D2D device.

The D2D gateway sends a response message of acceptance to the source D2D device through control plane signaling; the response message is sent within the time window specified by the discovery request.

S404: the D2D gateway sends indication information to an eNB through an MME.

The D2D gateway queries the MME and eNB on which the source/target D2D device is located according to the registration information of the D2D device; there might be one or more MMEs and eNBs.

The indication information is used to indicate the discovery request and is sent through control plane signaling.

S405: the eNB allocates a wireless resource and notifies the D2D device involved in the D2D discovery process.

The allocation can be dynamic allocation, static allocation or semi-static allocation, in which, the dynamic allocation is to allocate a different resource each time according to the type of the discovery request and the condition of network resources, the static allocation is to allocate a fixed resource each time, the semi-static allocation is to select a needed resource in a certain resource scope. The wireless resource adopts the uplink resource from UE to eNB.

The notification is sent through RRC signaling.

S406: the source D2D device sends D2D announcement information according to the received wireless resource information.

The D2D announcement information, sent through RRC signaling, is sent periodically, so as to improve the reliability of the target D2D device receiving the announcement information. The D2D announcement period is determined when the eNB allocates the wireless resource.

S407: a target D2D device monitors the D2D announcement information according to the received wireless resource information.

The target D2D device monitors the D2D announcement information on the allocated wireless resource according to the announcement period.

S408: the target D2D device which has monitored the announcement information sends a response message to the source D2D device. The process is ended.

Specifically, if the target D2D device has monitored the D2D announcement information, it sends a response message through the allocated wireless resource; if the target D2D device is a group of devices, part or all of the target D2D devices can send a response message.

The response message is RRC signaling, which is sent within the discovery time window.

S409: the D2D gateway sends a rejection message to the source D2D device.

When the D2D gateway determines that the D2D discovery request is not supported, the D2D gateway sends a rejection message to the source D2D device, and meanwhile specifies the rejection reason, for example, the target D2D device does not allow to be discovered, or the source D2D device and target D2D device do not belong to the same group, and so on.

The rejection message is sent through control signaling; if no response message of acceptance or rejection is received within the discovery time window, the source D2D device considers that the discovery request is failed.

### Embodiment 5

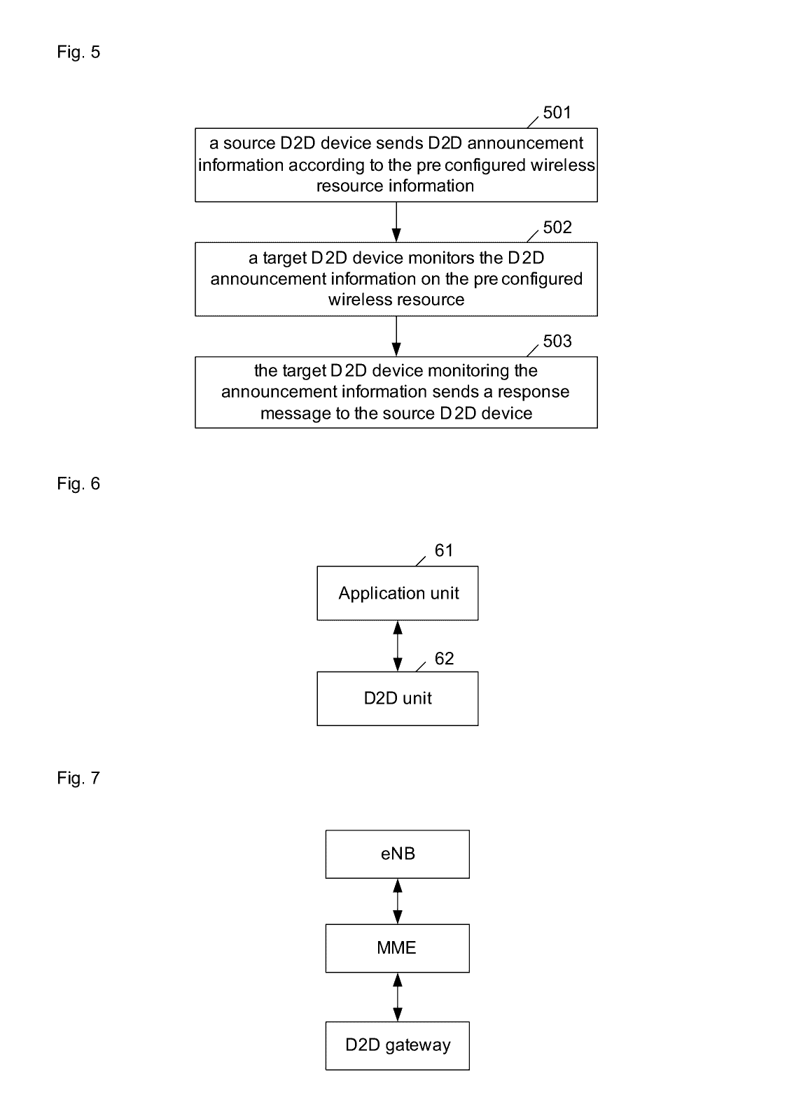

For the scene that a D2D device discovers a proximity D2D device in the condition of no network coverage, the method for D2D device discovery as shown in FIG. 5 includes:

S501: a source D2D device sends D2D announcement information according to the preconfigured wireless resource information.

The present wireless resource information refers to the resource configuration information stored in the D2D device before the discovery.

The preconfiguredting can be configured by a network side eNB when the D2D device is located in the network coverage or can be configured in advance by a D2D device manufacturer.

The preconfigured wireless resource information includes at least one of the following: frequency, frame/sub-frame, repetition interval (which is used to indicate the time interval for the D2D device to send/monitor announcement information on the wireless resource.), and resource index (which is used to indicate the wireless resource needed for different D2D discovery requirements, for example, point to point, point to multi-point, different distances between devices and other requirements).

S502: a target D2D device monitors the D2D announcement information on the preconfigured wireless resource.

The target D2D device monitors the D2D announcement information on the wireless resource according to the preconfigured period.

S503: the target D2D device which has monitored the announcement information sends a response message to the source D2D device.

The response message is sent through an RRC message, which is sent within the discovery time window. If no response message of acceptance or rejection is received within the discovery time window, the source D2D device considers that the discovery request is failed.

### Embodiment 6

In order to implement the above method, the embodiment of the disclosure provides a D2D device, which as shown in FIG. 6 includes: an application unit 61 and a D2D unit 62, wherein

the application unit 61 is configured to: determine whether there is network coverage, if so, send a request to discover one or more proximity D2D devices to the D2D unit 62, send announcement information through the D2D unit 62 according to the wireless resource information and monitor response information; if not, send announcement information through the D2D unit 62 according to the preconfigured wireless resource information and monitor response information;

the D2D unit 62 is configured to: send the request to discover one or more proximity D2D devices sent from the application unit 61, send the received wireless resource information to the application unit 61, and send out the announcement information sent from the application unit 61.

The application unit 61 specifically is configured to: determine whether there is network coverage according to the signaling interaction with a network side and the saved network side context information, and, if there is a normal signaling interaction with the network side and the network side context information already exists, determine that there is network coverage; otherwise, determine that there is no network coverage.

The request to discover one or more proximity D2D devices includes at least one of the following: a source identifier, a target identifier, an application identifier, an application server identifier, a group identifier, a network coverage indication, a discovery scope, a discovery time window and the like. The source identifier is used to indicate the D2D device that sends the request; the target identifier is used to indicate the target device expected to be discovered; the discovery scope is used to indicate the area for discovering the target; the discovery time window is used to indicate the valid time for discovery.

The wireless resource information is realized through RRC signaling; and the wireless resource information includes at least one of the following: frequency, frame/sub-frame, repetition interval, resource index.

The repetition interval is the time interval for the D2D device to send/monitor announcement information on the wireless resource.

Here, the announcement information includes at least one of the following: a source identifier (which is used to indicate the D2D device that sends the request), a target identifier (which is used to indicate the target device expected to be discovered), an application identifier, a group identifier, a network coverage indication, whether to support relay (which is used to indicate serving as relay), a discovery scope (which is used to indicate the area for discovering the target), a discovery time window (which is used to indicate the valid time for discovery) and the like. The D2D announcement information is sent through RRC signaling.

The preconfigured wireless resource information includes at least one of the following: frequency, frame/sub-frame, repetition interval (which is used to indicate the time interval for the D2D device to send/monitor announcement information on the wireless resource.), and resource index (which is used to indicate the wireless resource needed for different D2D discovery requirements, for example, point to point, point to multi-point, different distances between devices and other requirements).

The response information is: acknowledgement information of receipt sent to the source D2D device by the target D2D device, after the target D2D device receives the announcement information sent from the source D2D device. The response information is sent by the target D2D device on an allocated or preconfigured wireless resource.

The wireless resource information, the announcement information and the response information are sent through wireless resource control signaling.

The above application unit 61 and D2D unit 62 both can be realized through Central Processing Unit (CPU), Digital Signal Processor (DSP) and other hardware.

### Embodiment 7

The embodiment of the disclosure also provides a network side sub-system, which as shown in FIG. 7 includes: an eNB, an MME and a D2D gateway, wherein the D2D gateway is configured to send indication information to the MME after receiving a request to discover one or more proximity D2D devices;

the MME is configured to send the indication information sent from the D2D gateway to the eNB; and

the eNB is configured to allocate a wireless resource for the D2D device according to the indication information and to send the wireless resource information.

The D2D gateway specifically is configured to: determine whether the source D2D device and target D2D device in the request to discover one or more proximity D2D devices allow to discover or be discovered according to subscription data or locally stored data, if not, send rejection indication information and rejection reason to the source D2D device; otherwise, send indication information to the MME on which the source D2D device and target device are located.

The source D2D device and target D2D device might be located on the same or different MMEs.

The D2D gateway determines the information of the MME on which the D2D device is located according to D2D device identifier and D2D device registration information.

The MME sends indication information to the eNB on which the source D2D device and target D2D device are located; the source and target D2D devices might be located on the same or different eNBs. The MME determines the eNB on which the D2D device is located according to the D2D device registration information.

The indication information includes at least one of the following: a source identifier (which is used to indicate the D2D device that sends the request), a target identifier (which is used to indicate the target device expected to be discovered), an application identifier, a group identifier, a network coverage indication, a discovery scope (which is used to indicate the area for discovering the target), a discovery time window (which is used to indicate the valid time for discovery) and the like. The discovery time window can be realized by a timer.

### Embodiment 8

The system for D2D device discovery provided by the embodiment includes: a source D2D device and a network side sub-system, wherein

the source D2D device is configured to: determine whether there is network coverage, if so, send a request to discover one or more proximity D2D devices to the network side sub-system and receive wireless resource information, send announcement information according to the wireless resource information and monitor response information; if not, send announcement information according to the wireless resource information preconfigured in the source D2D device and monitor response information;

the network side sub-system is configured to allocate, after receiving the request to discover one or more proximity D2D devices from the source D2D device, a wireless resource for the D2D device according to the indication information and to send the wireless resource information to the source D2D device.

The network side sub-system includes: an eNB, an MME and a D2D gateway, wherein

the D2D gateway is configured to send indication information to the MME after receiving a request to discover one or more proximity D2D devices;

the MME is configured to send the indication information sent from the D2D gateway to the eNB; and

the eNB is configured to allocate a wireless resource for the D2D device according to the indication information and to send the wireless resource information.

The above are the preferred embodiments of the disclosure only, and are not intended to limit the scope of protection of the disclosure.

What is claimed is:

1. A method for discovering a Device to Device (D2D) device, comprising:
determining, by a source D2D device, whether there is network coverage;
when there is the network coverage, sending, by the source D2D device, a request to discover one or more proximity D2D devices, receiving wireless resource information, sending announcement information according to the wireless resource information and monitoring response information; and
when there is no network coverage, sending, by the source D2D device, announcement information according to the wireless resource information preconfigured in the source D2D device and monitoring response information.

2. The method according to claim 1, wherein the step of determining whether there is network coverage comprises:
determining, by the source D2D device, whether there is network coverage according to a signaling interaction with a network side and the network side context information saved in the source D2D device; if the source D2D device has a normal signaling interaction with the network side and the source D2D device has saved the network side context information, determining that there is network coverage; otherwise, determining that there is no network coverage.

3. The method according to claim 1, wherein the request to discover the one or more proximity D2D devices comprises at least one of the following: a source identifier, a target identifier, an application identifier, an application server identifier, a group identifier, a network coverage indication, a discovery scope, a discovery time window.

4. The method according to claim 1, wherein the wireless resource information comprises at least one of the following: a frequency, a frame/sub-frame, a repetition interval, a resource index.

5. The method according to claim 1, wherein the announcement information comprises at least one of the following: a source identifier, a target identifier, an application identifier, a group identifier, a network coverage indication, whether to support relay, a discovery scope, a discovery time window.

6. The method according to claim 1, wherein the response information is: receipt acknowledgement information sent to the source D2D device by a target D2D device, after the target D2D device receives the announcement information sent from the source D2D device; the response information is sent by the target D2D device on an allocated or a preconfigured wireless resource.

7. The method according to claim 1, wherein the wireless resource information, the announcement information and the response information are sent through wireless resource control signaling.

8. A method for discovering a Device to Device (D2D) device, comprising:
after a D2D gateway receives a request to discover one or more proximity D2D devices, sending, by the D2D gateway, indication information to an Evolved Node B (eNB) through a Mobile Management Entity (MME);
allocating, by the eNB, a wireless resource for the D2D device according to the indication information and sending the wireless resource information.

9. The method according to claim 8, wherein after the D2D gateway receives a request to discover one or more proximity D2D devices, sending, by the D2D gateway, indication information to an eNB through an MME comprises:
determining, by the D2D gateway, whether the source D2D device and target D2D device in the request to discover one or more proximity D2D devices allow to discover or be discovered according to subscription data or locally stored data;
if not, sending, by the D2D gateway, rejection indication information and rejection reason to the source D2D device;
otherwise, sending, by the D2D gateway, indication information to the MME on which the source D2D device and target device are located.

10. The method according to claim 8, wherein the indication information comprises at least one of the following: a source identifier, a target identifier, an application identifier, a group identifier, a network coverage indication, a discovery scope, a discovery time window.

11. A Device to Device (D2D) device, comprising: an application unit and a D2D unit, wherein
the application unit is configured to:
determine whether there is network coverage;
when there is the network coverage, send a request to discover one or more proximity D2D devices to the D2D unit, send announcement information through the D2D unit according to the wireless resource information and monitor response information;
when there is no network coverage, send announcement information through the D2D unit according to a preconfigured wireless resource information and monitor response information;
the D2D unit is configured to:
send the request to discover one or more proximity D2D devices sent from the application unit;
send the received wireless resource information to the application unit; and
send out the announcement information sent from the application unit and monitor response information.

12. The D2D device according to claim 11, wherein
the application unit is configured to: determine whether there is network coverage according to a signaling interaction with a network side and the saved network side context information, and, if there is a normal signaling interaction with the network side and the network side context information already exists, determine that there is network coverage; otherwise, determine that there is no network coverage.

13. The D2D device according to claim 11, wherein
the request to discover one or more proximity D2D devices comprises at least one of the following: a source identifier, a target identifier, an application identifier, an application server identifier, a group identifier, a network coverage indication, a discovery scope, a discovery time window.

14. The D2D device according to claim 11, wherein the wireless resource information comprises at least one of the following: a frequency, a frame/sub-frame, a repetition interval, a resource index.

15. The D2D device according to claim 11, wherein the announcement information comprises at least one of the following: a source identifier, a target identifier, an application identifier, a group identifier, a network coverage indication, whether to support relay, a discovery scope, a discovery time window.

16. The D2D device according to claim 11, wherein the response information is: receipt acknowledgement information sent to the source D2D device by a target D2D device, after the target D2D device receives the announcement information sent from the source D2D device; the response information is sent by the target D2D device on an allocated or a preconfigured wireless resource.

17. The D2D device according to claim 11, wherein the wireless resource information, the announcement information and the response information are sent through wireless resource control signaling.

18-21. (canceled)
